(19) United States
(12) Patent Application Publication
(10) Pub. No.: US 2007/0292701 A1
(43) Pub. Date: Dec. 20, 2007

(54) Novel Polyimide Film Improved in Adhesion

(76) Inventors: Takashi Kikuchi, Shiga (JP); Hisayasu Kaneshiro, Kyoto (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/663,702

(22) PCT Filed: Sep. 15, 2005
(86) PCT No.: PCT/JP05/17019

§ 371 Date: Mar. 23, 2007

(30) Foreign Application Priority Data
Sep. 24, 2004 (JP) 2004-277196

(51) Int. Cl. C08G 73/10; B32B 15/08; B32B 15/088

(52) U.S. Cl. 428/458; 528/170; 528/208

(57) ABSTRACT

Disclosed is a non-thermoplastic polyimide film obtained by imidating a polyamic acid-containing solution which is obtained by reacting an aromatic diamine containing 3,4′-diaminodiphenyl ether and 2,2-bis{4-(4-aminophenoxy)phenyl}propane with an aromatic acid dianhydride by a specific polymerization process. This polyimide film exhibits good adherability with respect to a metal foil via an adhesive layer containing a thermoplastic polyimide without being subjected to a special surface treatment.

### TECHNICAL FIELD

The present invention relates to a novel polyimide film which exhibits a high adherability without performing a special surface treatment on a surface thereof.

### BACKGROUND ART

The recent trends toward lighter, smaller, and higher-density electronic products have increased the demand for various printing boards. In particular, the demand for “flexible printing circuit boards (also referred to as (FPCs)”) has shown a notable increase. A flexible printing circuit board is constituted from an insulating film and a circuit formed from a metal foil disposed on the film.

A flexible metal-clad laminate, from which the flexible printing circuit boards is produced, is produced by bonding a metal foil onto a surface of a substrate with an adhesive material of various kinds under heating and pressure, the substrate being a flexible film made from an insulating material of various kinds. Polyimide films and the like are preferred as the insulating flexible film. The polyimide film is generally produced by casting, on a support, a solution of a polyamic acid produced by reacting a diamine and an acid dianhydride, and then volatilizing off a solvent from the solution to some extent thereby to obtain a gel film, and performing thermal or chemical imidation of the gel film.

Various studies have been conducted on structures of the diamine and acid dianhydride as the raw material monomers or conditions of the imidation. All the polyimide films obtained according to these studies are categorized as a group of plastic films that are very poor in adherability (a property for allowing adhesion thereto). Therefore, in reality, these films are subjected to a surface treatment of various kinds such as corona treatment, plasma treatment, flaming treatment, UV treatment, or the like, prior to providing an adhesion layer thereon after the film formation.

The poor adherability of the polyimide film have been explained in many ways. One explanation is that a weak boundary layer (WBL) is formed on a surface of the film during the film formation. That is, peeling occurs on an interface with the WBL, thereby causing the poor adherability. PCT (Pressure Cooker Test) or a long-time heating test encourage decomposition of the WBL, thereby further lowering the adherability. The surface treatment roughing the film surface, thereby removing the WBL. It is explained that this improves the film in adherability.

On the other hand, thermosetting adhesives such as epoxy-based, acrylic-based, or the like adhesives are typically used as an adhesive to adhere the polyimide film and a metal foil. It is expected that the thermosetting adhesives will not be able to cope with more severe demands in the future in terms of properties such as heat resistance, flexibility, electric reliability. Thus, it is suggested to use thermoplastic polyimides as adhesive agents.

The thermoplastic polyimides are, however, poorer in flowability than the thermosetting resins. Thus, the thermoplastic polyimides cannot be engaged with the material, whereby the thermoplastic polyimides cannot attain high adhesion. Therefore, there is a problem in that a metal foil and a polyimide film that is poor in adherability cannot be adhered with sufficient adhesion strength therebetween by using a thermoplastic polyimide adhesive layer cannot attain.

To solve this problem, various attempts have been suggested, such as (i) use of a film that is surface-treated as described above, (ii) lowering the glass transition temperature of the thermoplastic polyimide of the adhesive layer so as to give the adhesive layer better flowability, (iii) simultaneous formation of a core layer and the adhesive layer so as to above the formation of WBL (see Patent Citation 1, etc.).

However, the film surface treatment increases a number of steps in the process, and the cost. Low glass transition temperature of the thermoplastic polyimide causes problems in terms of heat resistance. The combination of the core layer and the adhesive layer for the simultaneous formation thereof cannot be altered easily.

[Patent Citation 1] Japanese Patent Application Publication, Tokukaihei, No. 3-180343

### DISCLOSURE OF INVENTION

### Technical Problem

In view of the aforementioned problem, an object of the present invention is to provide a polyimide film that does not require a special surface treatment in order to have a high adherability with respect to a metal layer, especially to have a high adherability with the metal layer via an adhesive layer. Especially, an object of the present invention is to provide a polyimide film that shows high adherability with a metal layer via an adhesive layer prepared from a thermoplastic polyimide.

### Technical Solution

The inventors of the present invention uniquely found that a particular production method dramatically improves adherability of a polyimide film. The production method uses a diamine component that contains 3,4′-diaminodiphenylether and 2,2-bis{4-(4-aminophenoxy)phenyl}propane. The present invention is based on this finding.

More specifically, the present invention provides the following novel polyimide films that can attain the objects.

1) A non-thermoplastic polyimide film prepared by performing imidation with a solution containing a polyamic acid obtained by reacting an aromatic diamine with an aromatic dianhydride, wherein:

the aromatic diamine includes 3,4′-diaminodiphenylether and 2,2-bis{4-(4-aminophenoxy)phenyl}propane, and

the solution is prepared by a method for preparing a polyamic acid solution, the method including:

(A) reacting, in an organic polar solvent, an aromatic dianhydride component (a) and an aromatic diamine component (b) in such amounts that one of the aromatic dianhydride component (a) and the aromatic diamine component (b) is excess to the other in molar amount, the aromatic diamine component (b) containing 3,4′-diaminodiphenylether, so as to obtain a flexible prepolymer having an amino group or an acid anhydride group on both ends; and

(B) synthesizing a polyimide precursor solution from the flexible prepolymer obtained in step (A), an aromatic acid dianhydride component (c), and an aromatic diamine component (d) in such amounts that make up equimolar amounts of aromatic acid dianhydride and aromatic diamine in the overall process.

2) The non-thermoplastic polyimide film as set forth in 1), wherein the diamine used in step (A) is a diamine of soft structure.

3) The non-thermoplastic polyimide film as set forth in 2), wherein the diamine used in step (B) is a diamine of rigid structure.

4) The non-thermoplastic polyimide film as set forth in 2) or 3), wherein the diamine of soft structure is 3,4′-diaminodiphenylether and/or 2,2-bis{4-(4-aminophenoxy)phenyl}propane.

5) The non-thermoplastic polyimide film as set forth in 4), wherein 3,4′-diaminodiphenylether is 10 mol % or more in the whole diamine component(s).

6) The non-thermoplastic polyimide film as set forth in 4) or 5), wherein 2,2-bis{4-(4-aminophenoxy)phenyl}propane is 10 mol % or more in the whole diamine component(s).

7) The non-thermoplastic polyimide film as set forth in any one of 1) to 4), wherein benzophenontetracarboxylic dianhydride is used in step (A).

8) The non-thermoplastic polyimide film as set forth in 7), wherein benzophenontetracarboxylic dianhydride is 5 mol % or more in the whole acid dianhydride component(s).

9) The non-thermoplastic polyimide film as set forth in 1) to 8), wherein the prepolymer obtained in step (A) is a block component derived from a thermoplastic polyimide.

10) The non-thermoplastic polyimide film as set forth in 1) to 9), wherein a laminate of a metal foil on the non-thermoplastic polyimide film via an adhesive layer shows metal foil peel strengths of 15N/cm or more in 90-degree peeling and 10N/cm or more in 180-degree peeling, where the non-thermoplastic polyimide is not surface-treated and the adhesive layer contains a thermoplastic polyimide.

11) The non-thermoplastic polyimide film as set forth in 10), wherein the laminate after treatment in which the laminate is kept in an environment of 121° C. and 100% R.H. for 96 hours shows 85% or more of metal foil peel strengths in 90-degree peeling and in 180-degree peeling compared with before the treatment, the laminate being obtained by laminating the polyimide film and the metal foil via the adhesive layer, where the non-thermoplastic polyimide film is not surface-treated and the adhesive layer contains a thermoplastic polyimide.

12) The non-thermoplastic polyimide film as set forth in 10) or 11), wherein the laminate after heated at 150° C. for 500 hours shows 85% or more of metal foil peel strengths in 90-degree peeling and in 180-degree peeling compared with before the heating, the laminate being obtained by laminating the polyimide film and the metal foil via the adhesive layer, where the non-thermoplastic polyimide film is not surface-treated and the adhesive layer contains a thermoplastic polyimide.

### Effect of the Invention

The polyimide film according to the present invention does not require a surface treatment, for example, in order to attain good adherability with a metal foil adhered thereto via an adhesive, while conventional polyimide films require such surface treatment. Especially, the polyimide film according to the present invention shows a high adherability even if an adhesive layer containing a thermoplastic polyimide, even though such an adhesive layer is poorly adhesive thereto compared with a thermosetting resin. Moreover, the adherability of the polyimide film according to the present invention will not be deteriorated much even after subjected to high-temperature and highly humid environments. Thus, the present invention can solve the problems of increases in the cost and the number of steps in the production.

### BEST MODE FOR CARRYING OUT THE INVENTION

The present invention attains excellent adherability as described above, especially, excellent adherability for an adhesive layer containing a thermoplastic polyimide. The present invention attains such excellent adherability by arranging such that a diamine component, which is one raw material of the polyimide film, contains 3,4′-diaminodiphenyl ether and 2,2-bis{4-(4-aminophenoxy)phenyl}propane, and specifying a method for polymerizing a polyamic acid, which is a precursor of the polyimide.

One embodiment of the preset invention is explained below.

(Production of Polyamic Acid)

In general, a polyamic acid, which is the precursor of the polyimide used in the present invention, is produced as follows. An aromatic diamine and an aromatic acid dianhydride in substantially equimolar amounts are dissolved into an organic solvent, so as to prepare a solution in which the polyamic acid is dissolved in the organic solvent. The solution is stirred under controlled temperature condition until completion of the polymerization of the acid dianhydride and diamine, thereby obtaining a polyamic acid solution. The polyamic acid solution is obtained generally in concentration of 5 to 35 wt. %, and preferably in concentration of 10 to 30 wt. %. The concentration within the range gives appropriate molecular weight and solution viscosity.

In order to attain the polyimide film having high adherability without special surface treatment, it is important to perform imidation of the polyamic acid solution obtained by carrying out the following steps (A) and (B).

Step (A) is a step for reacting, in an organic polar solvent, the aromatic acid dianhydride component (a) and an aromatic diamine component (b) in such amounts that either is greater in molar amount than the other, so as to prepare a prepolymer having an amino group or an acid dianhydride group on both ends.

Step (B) is a step for synthesizing a polyimide precursor solution from the flexible prepolymer obtained in step (A), an aromatic acid dianhydride component (c), and an aromatic diamine component (d) in such amounts that make up equimolar amounts of the aromatic acid dianhydride and the aromatic diamine in the overall process. Moreover, it is important that the aromatic component contains 3,4′-diaminodiphenyl ether and 2,2-bis{4-(4-aminophenoxy)phenyl}propane.

Examples of aromatic diamines that can be used as monomers from which the polyimide film of the present invention is produced encompass the following aromatic diamines and the like diamines: 4,4′-diaminodiphenylpropane, 4,4′-diaminodiphenylmethane, benzidine, 3,3′-dichlorobenzidine, 3,3′-dimethylbenzidine, 2,2′-dimethylbenzidine, 3,3′-dimethoxybenzidine, 2,2′-dimethoxybenzidine, 4,4′-diaminodiphenylsulfide, 3,3′-diaminodiphenylsulfone, 4,4′-diaminodiphenylsulfone, 4,4′-diaminodiphenylether, 3,3′-diaminodiphenylether, 3,4′-diaminodiphenylether, 1,5-diaminonaphthalene, 4,4′-diaminodiphenyldiethylsilane, 4,4′-diaminodiphenylsilane, 4,4′-diaminodiphenylethylphosphineoxide, 4,4′-diaminodiphenyl N-methylamine, 4,4′-diaminodiphenyl N-phenylamine, 1,4-diaminobenzene(p-phenylenediamine), 1,3-diaminobenzene, 1,2-diaminobenzene, bis{4-(4-aminophenoxy)phenyl}sulfone, bis{4-(3-aminophenoxy)phenyl}sulfone, 4,4′-bis(4-aminophenoxyl)biphenyl, 4,4′-bis(3-aminophenoxy)biphenyl, 2,2-bis{4-(4-aminophenoxy)phenyl}propane, 1,3-bis(3-aminophenoxy)benzene, 1,3-bis(4-aminophenoxy)benzene, 3,3′-diaminobenzophenone, 4,4′-diaminobenzophenoe, and the like.

It is preferable that the diamines for use in step (A) be flexible. With this arrangement, the prepolymer obtained in step (A) will be a block component made of thermoplastic polyimide. By carrying out the reaction in step (B) and performing film formation with the prepolymer, it is possible to obtain a polyamic acid and further a polyimide film in which thermoplastic sites are present in some parts of its molecular chain. In the present invention the flexible diamines are diamine having a soft structure, such as ether group, sulfone group, ketone group, sulfide group, or the like (hereinafter, such a diamine is referred to a soft structure diamine). The soft structure diamines are preferably represented by the following general formula (1): 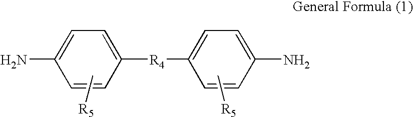
where R₄ is a group selected from the group consisting of divalent organic groups or linkage group represented as follows: 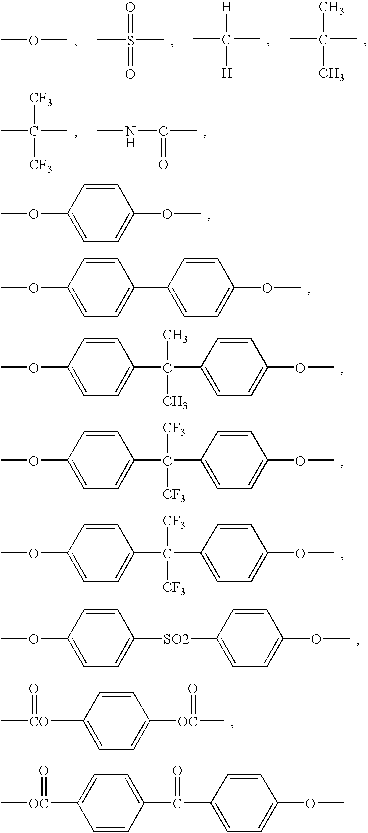
and R₅ is, independently or identically, a group selected from the group consisting of H—, CH₃—, —OH, —CF₃, —SO₄, —COOH, —CO—NH₂, Cl—, Br—, F—, and CH₃O—.

It has not fully understood why the polyimide film obtained via the steps attains high adherability even without the special treatment for attaining adherability as mentioned above. It would be an explanation that the flexible sites present some parts of the molecular chain prevents the WBL formation or somehow participates in the adhesion with the adhesive layer.

Furthermore, it is preferable that the diamine component for use in step (B) be a diamine having a rigid structure (hereinafter, this diamine is referred to as a rigid structure diamine), because this makes it possible to attain a non-thermoplastic film finally.

In the present invention, the rigid structure diamine is a diamine represented by the following general formula (2):
NH₂—R₂—NH₂ General Formula (2)
where R₂ is a group selected from divalent aromatic groups represented by general formula 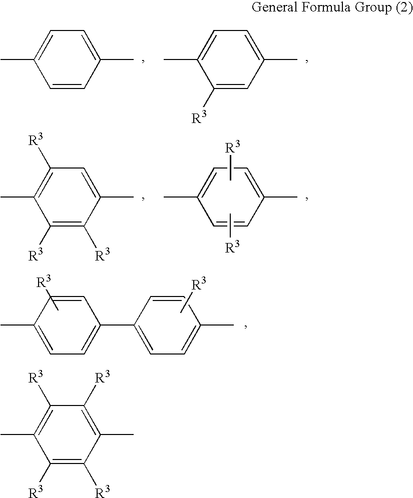
where R₃ is, independently or identically, a group selected from the group consisting of H—, CH₃—, —OH, —CF₃, —SO₄, —COOH, —CO—NH₂, Cl—, Br—, F—, and CH₃O—.

A molar ratio between the rigid structure diamine and soft structure diamines is in a range of 80:20 to 20:80, preferably in a range of 70:30 to 30:70, and especially preferably in a range of 60:40 to 40:60. If the ratio of the rigid structure diamine was greater than the ranges, the resultant film would possibly have insufficient adherability. On the contrary, if the ratio of the rigid structure diamine was less than the ranges, the resultant film would be too thermoplastic. Such a film would be thermally softened in the film formation, thereby tearing the film.

Plural kinds of the soft structure diamines and the rigid structure diamine may be used in combination. In the polyimide film of the present invention, however, it is important that one of the soft structure diamines is 3,4′-diaminodiphenylether.

The inventors of the present invention found that the use of 3,4′-diaminodiphenylether is quite effective to improve the adherability. Further, the inventors of the present invention found that the use of 3,4′-diaminodiphenylether slightly lowers linear expansion coefficient of the resultant polyimide film on contrary to the general behavior of the soft structure diamines that significantly increase the linear expansion coefficient of the resultant polyimide film to which they are added. Therefore, the use of 3,4′-diaminodiphenylether makes it easier to use another soft structure diamine in combination. The amount of 3,4′-diaminodiphenylether to use is preferably 10 mol % or more, and more preferably 15 mol % in the whole diamine component. If the amount of 3,4′-diaminodiphenylether was less in the ratio, the above-mentioned effect would not be attained possibly. On the other hand, an upper limit of the amount of 3,4′-diaminodiphenylether to use is preferably 50 mol % or less, and more preferably 40 mol % or less. A synergic effect of the rigid structure diamine with an amount of 3,4′-diaminodiphenylether more in the ratio would possibly result in too small linear expansion coefficient of the resultant polyimide film.

Furthermore, it is important to use 2,2-bis{4-(4-aminophenoxy)phenyl}propane as one of the soft structure diamines. The use of 2,2-bis{4-(4-aminophenoxy)phenyl}propane tends to lower water absorption or moisture expansion coefficient of the resultant polyimide film, thereby improving the resultant polyimide film in terms of moisture resistance. The amount of 2,2-bis{4-(4-aminophenoxy)phenyl}propane is preferably 10 mol % or more, and more preferably 15 mol % or more in the whole diamine component. If the amount of 2,2-bis{4-(4-aminophenoxy)phenyl}propane was less in the ratio, the above-mentioned effect would not be attained possibly. On the other hand, an upper limit of the amount of 2,2-bis{4-(4-aminophenoxy)phenyl}propane to use is preferably 40 mol % or less, and more preferably 30 mol % or less. If the amount of 2,2-bis{4-(4-aminophenoxy)phenyl}propane was more in the ratio, the linear expansion coefficient of the resultant polyimide film would be excessively large. Such an excessively large linear expansion coefficient would cause curling in laminating the polyimide film with a metal foil, or the like problem. The linear expansion coefficient of the polyimide film is preferably in a range of 5 to 18 ppm/° C. and more preferably in a range of 8 to 16 ppm/° C. at a temperature in a range of 100 to 200° C. Meanwhile, p-phenylenediamine can be adopted as the rigid structure diamine, or one of the rigid structure diamine. In case where p-phenylenediamine is used, the amount of p-phenylenediamine is preferably 60 mol % or less, and more preferably 50 mol % or less relative to the whole diamine component. The use of p-phenylenediamine with the small molecular weight increases a number of imide groups present in the polyimide of the same weight (that is, the concentration of the imide groups is increased). This would possibly cause a problem in moisture resistance or the like.

Examples of acid dianhydrides that can be used as monomers from which the polyimide film of the present invention is produced encompass the following acid dianhydrides and the like acid dianhydrides: pyromellitic dianhydride, 2,3,6,7-naphthalenetetracarboxylic dianhydride, 3,3′,4,4′-biphenyltetracarboxylic dianhydride, 1,2,5,6-naphthalenetetracarboxylic dianhydride, 2,2′,3,3′-biphenyltetracarboxylic dianhydride, 3,3′,4,4′-benzophenonetetracarboxylic dianhydride, 2,2′,3,3′-benzophenonetetracarboxylic dianhydride, 4,4′-oxyphthalic dianhydride, 3,4′-oxyphthalic dianhydride, 2,2-bis(3,4-dicarboxyphenyl)propanedianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxylphenyl)methane dianhydride, bis(3,4-dicarboxyphenyl)ethanedianhydride, oxydiphthalic dianhydride, bis(3,4-dicarboxyphenyl) sulfone dianhydride, p-phenylenebis(trimellitic acid monoester anhydride), ethylenebis(trimellitic acid monoester anhydride), bisphenol A bis(trimellitic acid monoester anhydride), and the like. Theses acid dianhydrides may be used solely or in combination in an appropriate ratio.

Like the diamines, acid anhydrides can be classified into soft structure acid dianhydrides and rigid structure acid dianhydrides, and it is preferable that a soft structure acid dianhydride be used in step (A), and a rigid structure acid dianhydride be used in step (B). In the present invention, the soft structure acid dianhydrides are acid dianhydrides having a soft structure such as ether group, sulfone group, ketone group, sulfide group, or the like. The rigid structure acid dianhydrides are such acid dianhydrides that an acid dianhydride group is attached to a benzene structure or naphthalene structure.

Examples of the acid anhydride that can be preferably used in step (A) encompass benzophenonetetracarboxylic dianhydrides, oxyphthalic dianhydrides, and biphenyltetracarboxylic dianhydrides. Above all, it is especially preferable to use benzophenonetetracarboxylic dianhydride. Benzophenonetetracarboxylic dianhydride is highly effective in increasing the adherabilitiy of the resultant polyimide. The amount of benzophenonetetracarboxylic dianhydride to use is preferably 5 mol % or more, and more preferably 10 mol % or more relative to the whole acid dianhydride component. An amount of benzophenonetetracarboxylic dianhydride less in the ratio would be insufficient to be effective enough. On the other hand, an upper limit of the amount of benzophenonetetracarboxylic dianhydride is preferably 30 mol % or less, and more preferably 20 mol % or less. An amount of benzophenonetetracarboxylic dianhydride more than the upper limit would result in very large water absorption, which is problematic in terms of moisture resistance. Moreover, this would possibly lead to excessively thermoplastic film. High thermoplasticity is problematic, for example, in film formation because the film is easily torn.

Examples of the acid anhydride that can be preferably used in step (B) encompass pyromellitic dianhydride. In case where pyromellitic dianhydride is used, the amount of pyromellitic dianhydride is preferably in a range of 40 to 95 mol %, more preferably in a range of 50 to 90 mol %, and especially preferably in a range of 60 to 80 mol %. The use of pyromellitic dianhydride in these ranges makes it easier to keep the linear expansion coefficient and film formability property at good levels.

Any solvents in which the polyimide precursor is soluble can be preferably used as the solvent for the synthesis of the polyamic acid. Amide-based solvents, such as N,N-dimethylformamide, N,N-dimethylacetoamide, N-methyl-2-pyrorridone, may be used as the solvent. Especially, N,N-dimethylformamide, and N,N-dimethylacetoamide are preferable.

Moreover, a filler may be added in order to attain better film properties such as slidability, heat conductivity, electric conductivity, corona resistance, loop stiffness, etc. Any kind of filler may be used. Preferable examples of the filler encompass silica, titanium oxide, alumina, silicon nitride, boron nitride, basic calcium phosphate, calcium phosphate, mica, and the like.

The diameter of the filler particles may be determined based on the film properties to be modified and the type of filler, and is thus not particularly limited. The average particle diameter is usually 0.05 to 100 μm, preferably 0.1 to 75 μm, more preferably 0.1 to 50 μm, and most preferably 0.1 to 25 μm. When the average diameter is below this range, the effect of modification is not readily exhibited. At an average diameter beyond this range, the surface quality and/or the mechanical properties may be significantly degraded. The amount of the filler to be added is determined based on the film properties to be modified and the diameter of the filler particles and is thus not particularly limited. The amount of the filler added is usually 0.01 to 100 parts by weight, preferably 0.01 to 90 parts by weight, and more preferably 0.02 to 80 parts by weight per 100 parts by weight of polyimide. At a filler content below this range, the effect of the modification by the use of the filler may not be sufficiently exhibited. At a filler content beyond this range, the mechanical properties of the film may be significantly degraded.

The filler may be added by any method. The examples of the method include:

1. Method of adding the filler to the polymerization solution before or during the polymerization;

2. Method of adding and kneading the filler into the polymerization solution with a three-shaft roller after completion of the polymerization; and

3. Method including preparing a dispersion containing the filler in advance and adding the dispersion into a polyamic acid organic solvent solution.

Any method may be employed for the addition of the filler. However, the method including preparing a dispersion containing the filler in advance and adding the dispersion into a polyamic acid organic solvent solution, especially right before the film formation is preferable because contamination of the production line with the filler in this method is least severe. In the preparation of dispersion containing the filler, it is preferable to use the same solvent as the polymerization solvent of the polyamic acid. In order to sufficiently disperse the filler and stabilize the dispersion state, a dispersant, a thickener, or the like may be used in amounts that do not adversely affect the properties of the film.

(Production of Polyimide Film)

The production of the polyimide film from the polyamic acid solution may be carried out by known methods, which encompass thermal imidation method and chemical imidation method. The thermal imidation method is a method for proceeding the imidation reaction by heat application without using a dehydrating agent or the like. The chemical imidation method is a method for facilitating the imidation reaction by using a dehydrating agent and/or imidation catalyst in the polyamic acid solution.

The dehydrating agent is a dehydrating and ring-closing agent for the polyamide acid. Examples of the dehydrating agent encompass aliphatic acid anhydride, aromatic acid anhydride, N,N′-dialkylcalbodiimide, lower aliphatic halides, halogenated lower aliphatic acid anhydride, allyl phosphonic diahalide, thionyl halides, and mixtures of two or more of these compounds. For availability and low cost, aliphatic anhydrides such as acetic anhydride, propionic anhydride, lactic anhydride, and the like, or mixtures of two or more of the aliphatic anhydrides.

The imidation catalyst is a component that can facilitate the dehydrating and ring-closing function to the polyamide acid. For example, aliphatic tertiary amines, aromatic tertiary amines, and heterocyclic tertiary amines may be the catalyst. Of these compounds, heterocyclic tertiary amines are especially preferable. More specifically, quinoline, isoquinoline, β-picoline, pyridine, and the like are preferable as the catalyst. Either of the imidation methods may be employed to produce the film. However, the chemical imidation method may be more easy to obtain a polyimide film having the various properties that are preferable in the present invention.

In the present invention, it is preferable that the production process of the polyimide film include:

a) reacting an aromatic diamine and an aromatic tetracarboxylic dianhydride in an organic solvent, so as to obtain a polyamic acid solution;

b) flow-casting, on a support, a film formation dope containing the polyamic acid solution;

c) heating the film formation dope on the support removing a gel film from the support; and

d) further heating the gel film so as to imidate residual amic acid and dry the gel film.

In the following, a preferable embodiment is described to explain the production process of the polyimide film. In the embodiment, the chemical imidation is explained for example. It should be noted that the present invention is not limited to the following arrangement descried by way of example, and the film formation condition and heating condition may be varied as appropriate according to the kinds of the polyamic acid, film thickness, etc.

For example, the dehydrating agent and imidation catalyst may be added into the polyamic acid solution at a low temperature thereby to prepare a film formation dope. Then, the film formation dope is cast on a support such as a glass board, an aluminum foil, endless stainless belt, stainless drum, or the like, thereby forming a film thereof on the support. The film on the support is heated in a temperature in arrange of 80° C. to 200° C., preferably in a range of 100° C. to 180° C. in order to activate the dehydrating agent and the imidation catalyst. Thereby, the film is partially cured and/or dried. Then, the film is removed from the support thereby obtaining a polyamic acid film (hereinafter this film is referred to as a gel film).

The gel film is in an intermediate state in the curing of the polyamic acid to the polyimide. The gel film is a self-supportive film. A volatile content of the gel film is expressed as formula (2):
(A−B)×100/B (2)
where A is a weight of the gel film, and B is a weight of the gel film after heated at 450° C. for 20 min. The volatile content of the gel film is in a range of 5 to 500 wt. %, preferably in a range of 5 to 200 wt. %, and more preferably in a range of 5 to 150 wt. %. It is preferable that the volatile content be in these ranges. If the volatile content is out of the range, a curing process would face a risk of film breakage, lack of uniformity in color tone of the film due to unevenly drying the film, and property variation, etc.

The amount of the dehydrating agent is in a range of 0.5 to 5 mol, and preferably in a range of 1.0 to 4 mol per unit of amid acid in the polyamic acid. Moreover, the amount of the imidation catalyst is in arrange of 0.05 to 3 mol, and preferably in a range of 0.2 to 2 mol per unit of amic acid in the polyamic acid. The chemical imidation would be insufficient when the amounts of the dehydrating agent and imidation catalyst are below the ranges. The insufficient chemical imidation would results in the film breakage during the curing or low mechanical strength. On the other hand, the imidation would proceed too fast when the amounts of the is dehydrating agent and imidation catalyst are above the ranges. The too-fast imidation would make it difficult to cast the solution into the film-like shape.

The gel film held at its ends is dried. By being held at its ends, the gel film can avoid the shrinkage due to the curing. The drying removes water, residual solvent, residual converting agent, and catalyst from the film, and completes the imidation of the residual amid acid. Thereby, the polyimide film of the present invention can be obtained. The drying is preferably carried out at a temperature in a range of 400 to 650° C. for a time period in a range of 5 to 400 sec. Drying carried out at a temperature higher than the range and/or for a time period longer than the range would possibly cause thermal deterioration in the film. On the other hand, drying carried out at a temperature lower than the range and/or for a time period shorter than the range would possibly fail to attain the desired effect.

Moreover, the heat treatment of the film may be carried out with the film stretched at a lowest tension necessary for conveying the film. This lowers an internal stress remained in the film. The heat treatment may be carried out during the film production process, or may be carried out in addition to the process. The heating condition cannot be specified because the heating condition varies depending on film property or apparatus to use. The internal stress can be alleviated by heating at a temperature generally not less than 200° C. but not more than 500° C., preferably not less than 250° C. but not more than 500° C., especially preferably not less than 300° C. but not more than 450° C., for a time period in a range of 1 to 300 sec, preferably in a range of 2 to 250 sec, and especially preferably in a range of 5 to 200 sec.

The polyimide film finally obtained via the process as described above should be non-thermoplastic. Films that do not melt and lose its film shape even when heated to a temperature approximately in a range of 450 to 500° C. are regarded as being non-thermoplastic. Therefore, the polyimide film, to have the above-mentioned composition, should be designed to be non-thermoplastic

The polyimide film according to the present invention thus obtained does not need special treatment on its surface in order to attain high adherability with respect to the metal foil adhered thereto via an adhesive layer. Especially, the polyimide film according to the present invention exhibits high adherability with respect to a metal foil adhered thereto via an adhesive layer containing a thermoplastic polyimide that is generally less adhesive thereto than the thermosetting resin. It is possible to attain such adhesive strength that metal foil peel strength of 15N/cm or more for 90-degree peeling and 10N/cm or more for 180-degree peeling.

(Adhesive Layer)

Preferable examples of the thermoplastic polyimide contained in the adhesive layer encompass thermoplastic polyimide, thermoplastic polyamideimide, thermoplastic polyetherimide, thermoplastic polyesterimide, etc. The present invention is not limited to a particular thermoplastic polyimide. The polyimide film according to the present invention can show high adherability regardless of using any thermoplastic polyimide. Moreover, the polyimide film can show high adherability even if a high-Tg type thermoplastic polyimide whose glass transition temperature (Tg) is 250° C. or more. The adhesive layer may be provided to the polyimide film by any known methods, and the metal foil may be adhered thereto by any known method. The present invention is not particularly limited as to how to provide the adhesive layer to the polyimide film and how to adhere the metal foil thereto. The non-thermoplastic polyimide film is quite effective in adhering a metal layer to the non-thermoplastic polyimide film via the adhesive layer as described above. Needless to say, the metal layer may be directed formed on the non-thermoplastic polyimide film by sputtering or the like method using no adhesive.

Moreover, the adherability of the polyimide film according to the present invention is not lowered much even under high temperature and high humidity condition. More specifically, even after keeping it in an environment of 121° C. and 100% R.H. for 96 hours, the adherability of the polyimide film after the treatment can be 85% or more of that of the film before the treatment in the metal foil peel strength for 90-degree peeling and 180-degree peeling.

Moreover, the adherability of the polyimide film according to the present invention is not lowered much even after long-time heating. More specifically, even after heating it at 150° C. for 500 hours, the adherability of the polyimide film after heating can be 85% or more of that of the film before heating in the metal foil peel strength for 90-degree peeling and 180-degree peeling.

Surface treatment is not necessary for the polyimide film according to the present invention in order to show the high adherability. The adherability of the present invention is maintained under high temperature and highly humid conditions. Thus, the present invention can provide a flexible wiring board of high reliability at low cost. Of course, the polyimide film of the present invention can be surface-treated. The application of the present invention is not limited to flexible wiring board. The present invention can be employed to various applications in which a laminate includes a metal foil.

### EXAMPLES

The present invention is explained in more details below referring to Examples. The present invention is not limited to these Examples.

In Synthesis Examples, Examples, and Comparative Examples, glass transition temperature measurement of thermoplastic polyimides, linear expansion coefficient measurement and non-thermoplasticity evaluation of polyimide films, metal foil peel strength measurement of flexible metal-clad laminate were carried out as follows.

(Glass Transition Temperature)

The glass transition temperature was measured with DMS6100 manufactured by SII Nanotechnology Inc. The temperature at the inflection point of the storage modulus was assumed as the glass transition temperature.

Measured Sample Range; Width: 9 mm, Distance between Holding Tools: 20 mm

Measured Temperature Range; 0 to 440° C.

Heating Rate; 3° C./min

Distortion Amplitude; 10 μm

Frequencies for measurement; 1, 5, and 10 Hz

Minimum Tension/Compressive Force; 100 mN

Tension/Compression Gain; 1.5

Initial Value of Force Amplitude; 100 mN

(Linear Expansion Coefficient of Polyimide Film)

The linear expansion coefficient of the polyimide film obtained was measured by using Thermo-mechanical Analysis Instrument TMA/SS6100 manufactured by SII Nanotechnology Inc. To measure the linear expansion coefficient, the polyimide film was heated from 0 to 460° C., and then cooled down to 10° C. After that, the polyimide film was heated at the heating rate of 10° C./min. The polyimide film was measured at 100° C. to 200° C. in the second heating. The measurements were averaged to work out the linear expansion coefficient of the polyimide film. The linear expansion coefficient was performed with respect to the MD direction and the TD direction of the core film.

Sample Size; Width 3 mm, Length 10 mm

Load; 29.4 mN

Temperature Range in Measurement: 0 to 460° C.

Heating Rate; 10° C./min

(Plasticity Evaluation)

The plasticity was evaluated by holding a prepared film of 20×20 cm to a frame made of SUS in a square shape (outer frame 20×20 cm, inner frame 18×18 cm), and then heating the film at 450° C. for 3 min. Films which maintained their shapes after the heat treatment were judged as non-thermoplastic, while films which shrank or extended were judged as thermoplastic.

(Metal Foil Peel-Strength: Initial Adhesion Strength)

A sample was prepared according to “6.5 Peel Strength” of JIS C6471. Measured was a load necessary for peeling a metal foil portion of 5 mm width at the peeling angle of 180 degrees at a rate of 50 mm/min. similar measurement was carried out to measure a load necessary for peeling a metal foil portion of 1 mm width at the peeling angle of 90 degrees at a rate of 50 mm/min.

(Metal Foil Peel Strength: Post Pct Adhesion Strength)

In a pressure cooker testing apparatus made by Hirayama Seisakusho (Product Name:PC-422RIII), a sample prepared in the same manner as in the initial adhesion strength test was introduced and left in an environment of 121° C. and 100% R.H. for 96 hours. Then the sample was taken out from the pressure cooker testing apparatus and measured in adhesion strength in the same manner as in the initial adhesion strength test.

(Metal Foil Peel Strength: Heating Treatment Adhesion Strength)

Into an oven that was set to 150° C., a sample prepared in the same manner as in the initial adhesion strength test was introduced and left for 500 hours. Then the sample was taken out from the oven and measured in adhesion strength in the same manner as in the initial adhesion strength test.

### Synthetic Example 1

### Synthesis of Thermoplastic Polyimide Precursor

To a 2,000 mL glass flask, 780 g of N,N-dimethylformamide (hereinafter, also referred to as DMF) and 117.2 g of bis[4-(4-aminophenoxy)phenyl]sulfone (hereinafter, also referred to as BAPS) were added. While the resulting mixture was being stirred in a nitrogen atmosphere, 71.7 g of 3,3′4,4′-biphenyltetracarboxylic dianhydride (hereinafter, also referred to as BPDA) was gradually added to the mixture. Subsequently, 5.6 g of 3,3′,4,4′-ethylene glycol dibenzoate tetracarboxylic dianhydride (hereinafter, also referred to as TMEG) was added, and the resulting mixture was stirred in an ice bath for 30 minutes. A solution of 5.5 g of TMEG in 20 g of DMF was separately prepared and gradually added to the reaction solution while monitoring the viscosity under stirring. The addition and the stirring were ceased when the viscosity reached 3,000 poise. A polyamic acid solution was thereby obtained was flow-cast on a 25 μm PET film (Cerapeel HP, produced by Toyo Metallizing Co., Ltd.) so that the final thickness was 20 μm, and dried at 120° C. for 5 minutes. The resulting self-supporting film after the drying was peeled from the PET film, held onto a metal pin frame, and dried at 150° C. for 5 minutes, at 200° C. for 5 minutes, at 250° C. for 5 minutes, and at 350° C. for 5 minutes. The glass transition temperature of thus obtained single-layer sheet was 270° C.

### Examples 1 to 6

In a reaction system kept at 5° C., 3,4′-diaminodiphenyl ether (hereinafter also referred to 3,4′-ODA) and 2,2-bis[4-(4-aminophenoxy)phenyl]propane (hereinafter, also referred to as BAPP) in a molar ratio shown in Table 1 were added to DMF, and stirred. After dissolution of 3,4′-ODA and BAPP was visually checked, benzophenonetetracarboxylic dianhydride (hereinafter, also referred to as BTDA) was added in a molar ratio shown in Table 1 and stirred for thirty minutes.

Then, pyromellitic dianhydride (hereinafter, also referred to as PMDA) was added in a molar ratio shown in Table 1 and stirred for thirty minutes. Subsequently, p-phenylenediamine (hereinafter, also referred to as p-PDA) was added in a molar ratio shown in Table 1 and stirred for fifty minutes. Subsequently, PMDA was again added in a molar ration shown in Table 1 and stirred for thirty minutes.

At the end, 3 mol % of PMDA was dissolved into DMF to prepare a solution with a PMDA solid content of 7%. The solution prepared was gradually added to the above-mentioned reaction solution while monitoring the viscosity under stirring. The polymerization was ceased when the viscosity reached 4,000 poise at 20° C.

To this polyamic acid solution, an imidation accelerator composed of acetic anhydride/isoquinoline/DMF (ratio of 2.0/0.3/4.0 based on weight) was added so as to be a ratio of 45% based on weight with respect to the polyamic acid solution and continuously stirred by a mixer. The resulting mixture was extruded from a T die and flow-cast on an endless belt made of stainless steel that runs 20 mm below the die. This resin film was heated at 130° C. for 100 seconds. The resulting self-supporting gel film (volatile content: 30 wt %) was peeled off from the endless belt. This resulting gel film was held on a tenter clip and then transferred into a heating furnace. The gel film was dried in a hot-air drying furnace at 300° C. for 30 seconds, in a hot-air drying furnace at 400° C. for 30 seconds, and in an IR furnace at 500° C. for 30 seconds for continuous drying and imidation. As a result, a polyimide film having a thickness of 18 μm was obtained. The polyimide film thus obtained was non-thermoplastic. By using a comma coater, the polyamic acid prepared in Synthesis Example 1 was applied on one side of the polyimide film so that a thermoplastic polyimide layer (adhesive layer) would be finally 3.5 μm in thickness on one side. Then, the thus prepared laminate was heated by passing through a drying oven that was set at 140° C. Next, the laminate was passed through an infra-red heater furnace of 390° C. atmospheric temperature for 20 seconds, thereby performing thermal imidation. Thereby, an adhesive film was obtained.

On the adhesive layer of the adhesive film thus prepared, a 18 μm rolled copper foil (BHY-22B-T, Japan Energy Corp.) was provided. The adhesive film and the copper foil provided thereon were sandwiched with polyimide films (Apical 125 NPI, Kaneka Corp.), and passed through heat roll laminating apparatus (which was set at lamination temperature of 380° C., lamination pressure of 196N/cm (20 kgf/cm), and lamination rate of 1.5 m/min), thereby adhering the copper foil with the adhesive layer.

### Example 7

In a reaction system kept at 5° C., BTDA and PMDA in a molar ratio shown in Table 1 were added to DMF, and stirred. After dissolution of BTDA and PMDA was visually checked, 3,4′-ODA and BAPP were added in a molar ratio shown in Table 1 and stirred for thirty minutes.

Then, PMDA was added in a molar ratio shown in Table 1 and dissolved therein. Subsequently, p-PDA was added in a molar ratio shown in Table 1 and stirred for fifty minutes. At the end, 3 mol % of p-PDA was dissolved into DMF to prepare a solution with solid content of 5%. The solution prepared was gradually added to the above-mentioned reaction solution while monitoring the viscosity under stirring. The polymerization was ceased when the viscosity reached 4,000 poise at 20° C.

Using the thus obtained polyamic acid solution, the same process as in Example 1 was carried out, thereby obtaining a polyimide film of 18 μm in thickness, and an adhesive film and a copper-clad laminate prepared therefrom.

### Comparative Example 1

In the same manner as in Examples, an adhesive layer was provided on a polyimide film (Apical 18HP GF, Kaneka Corp.), which was 18 μm in thickness and untreated, and a copper foil was adhered thereon.

### Comparative Example 2

In the same manner as in Examples, an adhesive layer is was provided on a polyimide film (Apical 20NPI GF, Kaneka Corp.), which was 20 μm in thickness and untreated, and a copper foil was adhered thereon.

### Comparative Example 3

In the same manner as in Examples, an adhesive layer was provided on a polyimide film (Apical 18HPP, Kaneka Corp.), which was 18 μm in thickness and whose surface was treated with plasma treatment, and a copper foil was adhered thereon.

### Comparative Example 4

In the same manner as in Examples, an adhesive layer was provided on a polyimide film (Apical 20NPP, Kaneka Corp.), which was 20 μm in thickness and whose surface was treated with plasma treatment, and a copper foil was adhered thereon.

Results of evaluation on properties of the polyimide films obtained in Examples and Comparative Examples are shown on Table 2.

TABLE 1

| | | | | PMDA | | PMDA |
|---|---|---|---|---|---|---|
| | 3,4′-ODA | BAPP | BTDA | (1st) | p-PDA | (2nd) |
| Example 1 | 20 | 25 | 20 | 20 | 55 | 57 |
| Example 2 | 30 | 20 | 20 | 25 | 50 | 52 |
| Example 3 | 30 | 20 | 10 | 35 | 50 | 52 |
| Example 4 | 20 | 30 | 20 | 25 | 50 | 52 |
| Example 5 | 10 | 40 | 20 | 25 | 50 | 52 |
| Example 6 | 20 | 30 | 10 | 35 | 50 | 52 |
| Example 7 | 20 | 25 | 20 | 30 | 52 | 50 |

TABLE 2

| | | | Adhesion Strength (N/cm) | | | | | |
|---|---|---|---|---|---|---|---|---|
| | | | 90-degree Peeling | | | 180-degree Peeling | | |
| | Film Linear Expansion | | (retention %) | | | (retention %) | | |
| | Coefficient (ppm/° C.) | | | | Heat | | | Heat |
| | MD | TD | Initial | Post PCT | Treatment | Initial | Post PCT | Treatment |
| Example 1 | 5.1 | 5.0 | 18.5 | 17.8 | 17.9 | 17.0 | 16.5 | 16.3 |
| | | | | (96%) | (97%) | | (97%) | (96%) |
| Example 2 | 6.5 | 6.5 | 19.0 | 18.7 | 18.5 | 16.6 | 16.1 | 15.7 |
| | | | | (98%) | (97%) | | (97%) | (98%) |
| Example 3 | 6.5 | 6.7 | 18.3 | 17.5 | 17.6 | 15.8 | 15.2 | 14.9 |
| | | | | (96%) | (96%) | | (96%) | (94%) |
| Example 4 | 9.1 | 9.0 | 21.6 | 20.9 | 21.2 | 17.5 | 16.4 | 16.3 |
| | | | | (97%) | (98%) | | (94%) | (93%) |
| Example 5 | 12.6 | 12.4 | 19.5 | 19.1 | 18.8 | 18.0 | 17.3 | 17.4 |
| | | | | (98%) | (96%) | | (96%) | (97%) |
| Example 6 | 8.6 | 8.6 | 19.2 | 18.6 | 18.5 | 18.0 | 17.5 | 17.2 |
| | | | | (97%) | (96%) | | (97%) | (96%) |
| Example 7 | 5.0 | 5.0 | 18.3 | 16.5 | 17.3 | 17.0 | 15.5 | 16.3 |
| | | | | (90%) | (95%) | | (91%) | (96%) |
| Comparative | 12.4 | 12.0 | 1.0 | 0 | 0 | 1.5 | 0 | 0 |
| Example 1 | | | | (0%) | (0%) | | (0%) | (0%) |
| Comparative | 16.4 | 15.5 | 2.2 | 0 | 0 | 2.4 | 0 | 0 |
| Example 2 | | | | (0%) | (0%) | | (0%) | (0%) |
| Comparative | 12.5 | 12.1 | 8.3 | 6.1 | 8.0 | 9.6 | 8.4 | 9.3 |
| Example 3 | | | | (73%) | (96%) | | (88%) | (97%) |
| Comparative | 16.6 | 15.8 | 11.5 | 9.3 | 10.7 | 12.0 | 9.8 | 11.2 |
| Example 4 | | | | (81%) | (93%) | | (82%) | (93%) |

As shown in Comparative Examples 1 and 2, the untreated polyimide films were significantly poor in the initial adhesion strength, and lost the adherability after PCT or the heat treatment. Meanwhile, the polyimide films in Examples 1 to 7 showed high initial adhesion strength both for 90-degree peeling and 180-degree peeling. The PCT and the heat treatment caused merely a little decrease in the adhesion strength of the polyimide films in Examples 1 to 7. Moreover, the adhesion strength of the polyimide films in Examples 1 to 7 were equivalent to or greater than that of the plasma-treated polyimide films in Comparative Examples 3 and 4.

### INDUSTRIAL APPLICABILITY

The polyimide film according to the present invention does not require a surface treatment, for example, in order to attain good adherability with a metal foil adhered thereto via an adhesive agent, while conventional polyimide films require such surface treatment. Especially, the polyimide film according to the present invention shows a high adherability even if an adhesive layer containing a thermoplastic polyimide, even though such an adhesive layer is poorly adhesive thereto compared with a thermosetting resin. Moreover, the adherability of the polyimide film according to the present invention will not be deteriorated much even after subjected to high-temperature and highly humid environments. Thus, the present invention can solve the problems of increases in the cost and the number of steps in the production.

1. A non-thermoplastic polyimide film prepared by performing imidation with a solution containing a polyamic acid obtained by reacting an aromatic diamine with an aromatic dianhydride, wherein:
the aromatic diamine includes 3,4′-diaminodiphenylether and 2,2-bis{4-(4-aminophenoxy)phenyl}propane, and
the solution is prepared by a method for preparing a polyamic acid solution, the method including:
(A) reacting, in an organic polar solvent, an aromatic dianhydride component (a) and an aromatic diamine component (b) in such amounts that one of the aromatic dianhydride component (a) and the aromatic diamine component (b) is excess to the other in molar amount, the aromatic diamine component (b) containing 3,4′-diaminodiphenylether, so as to obtain a flexible prepolymer having an amino group or an acid anhydride group on both ends; and
(B) synthesizing a polyimide precursor solution from the flexible prepolymer obtained in step (A), an aromatic acid dianhydride component (c), and an aromatic diamine component (d) in such amounts that make up equimolar amounts of aromatic acid dianhydride and aromatic diamine in the overall process.

2. The non-thermoplastic polyimide film as set forth in claim 1, wherein the diamine used in step (A) is a diamine of soft structure.

3. The non-thermoplastic polyimide film as set forth in claim 2, wherein the diamine used in step (B) is a diamine of rigid structure.

4. The non-thermoplastic polyimide film as set forth in claim 2, wherein the diamine of soft structure is 3,4′-diaminodiphenylether and/or 2,2-bis{4-(4-aminophenoxy)phenyl}propane.

5. The non-thermoplastic polyimide film as set forth in claim 4, wherein 3,4′-diaminodiphenylether is 10 mol % or more of the whole diamine component(s).

6. The non-thermoplastic polyimide film as set forth in claim 4, wherein 2,2-bis{4-(4-aminophenoxy)phenyl}propane is 10 mol % or more of the whole diamine component(s).

7. The non-thermoplastic polyimide film as set forth in claim 1, wherein benzophenontetracarboxylic dianhydride is used in step (A).

8. The non-thermoplastic polyimide film as set forth in claim 7, wherein benzophenontetracarboxylic dianhydride is 5 mol % or more in the whole acid dianhydride component(s).

9. The non-thermoplastic polyimide film as set forth in claims 1, wherein the prepolymer obtained in step (A) is a block component derived from a thermoplastic polyimide.

10. The non-thermoplastic polyimide film as set forth in claims 1, wherein a laminate of a metal foil on the non-thermoplastic polyimide film via an adhesive layer shows metal foil peel strengths of 15N/cm or more in 90-degree peeling and 10N/cm or more in 180-degree peeling, where the non-thermoplastic polyimide film is not surface-treated and the adhesive layer contains a thermoplastic polyimide.

11. The non-thermoplastic polyimide film as set forth in claim 10, wherein the laminate after treatment in which the laminate is kept in an environment of 121° C. and 100% R.H. for 96 hours shows 85% or more of metal foil peel strengths in 90-degree peeling and in 180-degree peeling compared with before the treatment, the laminate being obtained by laminating the polyimide film and the metal foil via the adhesive layer, where the non-thermoplastic polyimide film is not surface-treated and the adhesive layer contains a thermoplastic polyimide.

12. The non-thermoplastic polyimide film as set forth in claim 10, wherein the laminate after heated at 150° C. for 500 hours shows 85% or more of metal foil peel strengths in 90-degree peeling and in 180-degree peeling compared with before the heating, the laminate being obtained by laminating the polyimide film and the metal foil via the adhesive layer, where the non-thermoplastic polyimide film is not surface-treated and the adhesive layer contains a thermoplastic polyimide.

13. The non-thermoplastic polyimide film as set forth in claim 3, wherein the diamine of soft structure is 3,4′-diaminodiphenylether and/or 2,2-bis{4-(4-aminophenoxy)phenyl}propane.

14. The non-thermoplastic polyimide film as set forth in claim 13, wherein 3,4′-diaminodiphenylether is 10 mol % or more of the whole diamine component(s).

15. The non-thermoplastic polyimide film as set forth in claim 5, wherein 2,2-bis{4-(4-aminophenoxy)phenyl}propane is 10 mol % or more of the whole diamine component(s).

16. The non-thermoplastic polyimide film as set forth in claim 13, wherein 2,2-bis{4-(4-aminophenoxy)phenyl}propane is 10 mol % or more of the whole diamine component(s).

17. The non-thermoplastic polyimide film as set forth in claim 14, wherein 2,2-bis{4-(4-aminophenoxy)phenyl}propane is 10 mol % or more of the whole diamine component(s).

18. The non-thermoplastic polyimide film as set forth in claim 2, wherein benzophenontetracarboxylic dianhydride is used in step (A).

19. The non-thermoplastic polyimide film as set forth in claim 3, wherein benzophenontetracarboxylic dianhydride is used in step (A).

20. The non-thermoplastic polyimide film as set forth in claim 4, wherein benzophenontetracarboxylic dianhydride is used in step (A).
